(19) United States
(12) Patent Application Publication
(10) Pub. No.: US 2011/0010723 A1
(43) Pub. Date: Jan. 13, 2011

(54) INFORMATION PROCESSING APPARATUS, INFORMATION PROCESSING METHOD AND COMPUTER-READABLE STORAGE MEDIUM

(75) Inventor: Kiwamu OKABE, Kanagawa (JP)

Correspondence Address: IPUSA, P.L.L.C, 1054 31ST STREET, N.W., Suite 400, Washington, DC, 20007, US

(73) Assignee: RICOH COMPANY, LTD.

(21) Appl. No.: 12/824,193

(22) Filed: Jun. 27, 2010

(30) Foreign Application Priority Data
Jul. 7, 2009 (JP) 2009-161108
May 13, 2010 (JP) 2010-111465

(51) Int. Cl. G06F 9/46; G06F 3/00

(52) U.S. Cl. 719/312

(57) ABSTRACT

An information processing apparatus has a communication unit to perform an inter-process communication via a kernel space among a plurality of processes existing in a user space, and a log recording unit to record a log of the inter-process communication within the kernel space.

### CROSS-REFERENCE TO RELATED APPLICATIONS

This application claims the benefit of Japanese Patent Applications No. 2009-161108 filed on Jul. 7, 2009 and No. 2010-111465 filed on May 13, 2010, in the Japanese Patent Office, the disclosures of which are hereby incorporated by reference.

### BACKGROUND OF THE INVENTION

1. Field of the Invention

The present invention relates to information processing apparatuses, information processing methods, and computer-readable storage media, configured to acquire and record logs of inter-process communications.

2. Description of the Related Art

An information processing apparatus is not formed by a single program set, but is segmented into a plurality of modules that are called processes and execute coordinated operations. The processes communicate with each other in order to execute the coordinated operations. Such a communication between the processes is referred to as an Inter-Process Communication (IPC), and a socket is one type of implementation (API: Application Programming Interface) of the IPC.

FIG. 1 is a diagram for explaining a mechanism of the IPC using the socket. When a client process 11 sends a message to a server process 12, the client process 11 first prepares a message packet, as indicated by “(2) write( )”. This message packet has a structure illustrated in FIG. 2, for example.

FIG. 2 is a diagram illustrating an example of the structure of the message packet. The message packet illustrated in FIG. 2 is formed by an IPC packet that includes a header part and a message part. The header part precedes the message part, and includes a type indicating an API identification number (API-ID number) of the server process 12 that is called by the IPC, a packet size indicating a overall size of the IPC packet, and a sender indicating a process number of the source that sent the message packet. The message part includes a body of data to be sent (that is, sending data).

The message packet is not sent from the client process 11 within a user space directly to the server process 12, but is first delivered to a reception buffer 13 of a socket 14 of an Operating System (OS) within a kernel space. The kernel includes the message packet by a mbuf buffer 15, as indicated by “(3) include message by mbuf”.

Next, the mbuf buffer 15 is linked to a reception buffer 16 of a socket 17 at a sending destination, as indicated by “(4) link to buffer”. A plurality of mbuf buffers 15 that have already arrived but have not yet been read are linked in the reception buffer 16.

The server process 12 calls a “select( )” function at the sending destination socket 17 in order to match the arrival timings of the message packets, as indicated by “(1) select( )”. When the mbuf buffer 15 reaches the reception buffer 16 at the sending destination socket 17, the timing matching by the “select( )” function is cancelled, as indicated by “(5) cancel timing matching by select( )”, and the server process 12 resumes operation. The server process 12 recognizes from the result of the “select( )” function that the message packet has arrived at the sending destination socket 17, and starts to read the header part of the message packet, as indicated by “(6) read( )”. The remaining body of the sending data of the message packet is read from the sending destination socket 17, based on the packet size, within the header part, indicating the overall size of the message packet, as indicated by “(7) read( )”. The server process 12 finds the API within the server process 12, based on the type, within the header part, indicating the API-ID number of the server process 12 that is called by the IPC, and sends the sending data to the API that is found.

When debugging the IPC via the socket in the IPC mechanism described above, a process that operates in the user space, such as an IPC library, writes a log in a shared memory 18 that is prepared in the user space, as illustrated in FIG. 3. FIG. 3 is a diagram for explaining a debugging of the IPC via the socket in the IPC mechanism. In FIG. 3, those parts that are the same as those corresponding parts in FIG. 1 are designated by the same reference numerals, and a description thereof will be omitted.

The applicant is aware of Japanese Laid-Open Patent Publications No. 2001-318810, No. 2003-150357, and No. 5-61732, proposing examples of such debugging of the IPC via the socket.

According to the proposed examples of such debugging of the IPC via the socket, it is possible to debug a phenomenon that occurred within the user space. However, there was a problem in that troubles (or discrepancies) occurring within the OS, that is, in the kernel, cannot be observed. In addition, a memory corruption may occur within the user space, to thereby cause corruption of the packet that is sent from the user space to the OS. Hence, there was a problem in that it is difficult to analyze such troubles solely from the log in the user space.

### SUMMARY OF THE INVENTION

Accordingly, it is a general object of the present invention to provide a novel and useful information processing apparatus, information processing method and computer-readable storage medium, in which the problems described above are suppressed.

Another and more specific object of the present invention is to provide an information processing apparatus, an information processing method and a computer-readable storage medium, that may record a log of a behavior of an OS, and may detect troubles that cause memory corruption within a user space.

According to one aspect of the present invention, there is provided an information processing apparatus comprising a communication unit configured to perform an inter-process communication via a kernel space among a plurality of processes existing in a user space; and a log recording unit configured to record a log of the inter-process communication within the kernel space.

According to one aspect of the present invention, there is provided an information processing method, comprising performing, by a computer, an inter-process communication via a kernel space among a plurality of processes existing in a user space; and recording, by the computer, a log of the inter-process communication within the kernel space.

According to one aspect of the present invention, there is provided a computer-readable storage medium that stores a program which, when executed in a computer, causes the computer to perform a process comprising a communication procedure causing the computer to perform an inter-process communication via a kernel space among a plurality of processes existing in a user space; and a log recording procedure causing the computer to record a log of the inter-process communication within the kernel space.

Other objects and further features of the present invention will be apparent from the following detailed description when read in conjunction with the accompanying drawings.

### BRIEF DESCRIPTION OF THE DRAWINGS

FIG. 1 is a diagram for explaining a mechanism of an IPC using a socket;

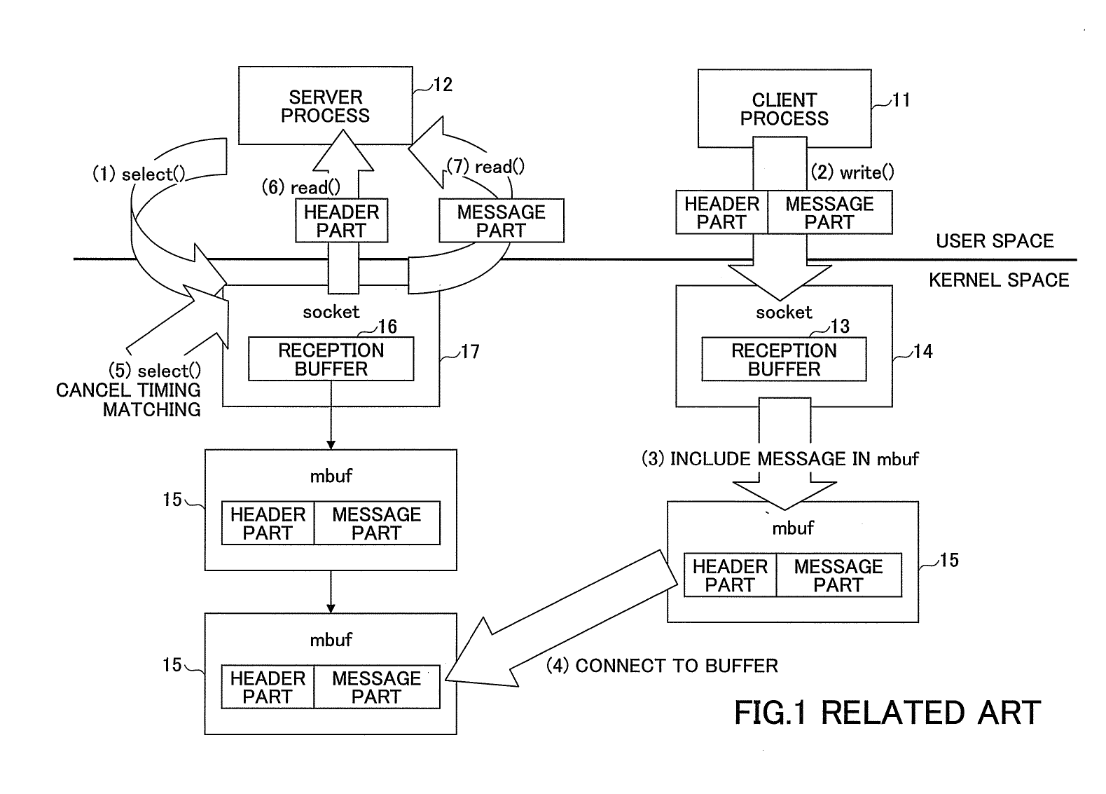

FIG. 2 is a diagram illustrating an example of a structure of a message packet;

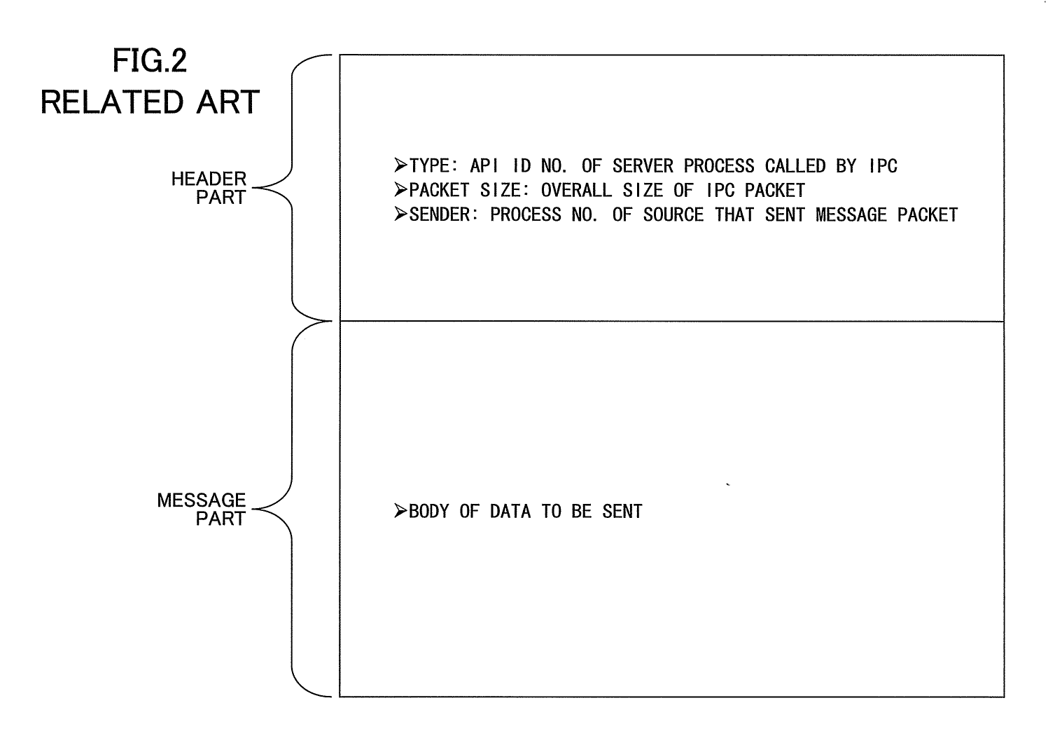

FIG. 3 is a diagram for explaining a debugging of the IPC via the socket in the IPC mechanism;

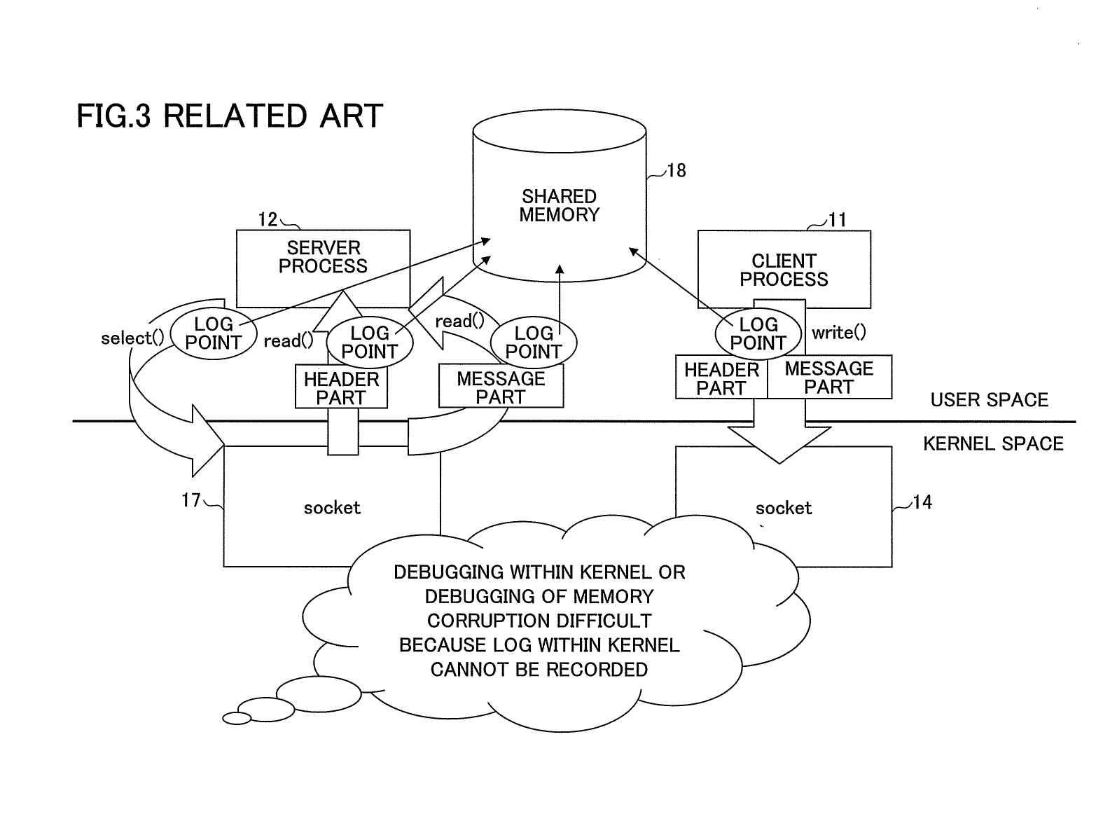

FIG. 4 is a diagram illustrating software hierarchical layers of an information processing apparatus in a first embodiment of the present invention;

FIG. 5 is a diagram for explaining an operation of the information processing apparatus in the first embodiment;

FIG. 6 is a diagram for explaining an operation of a general socket;

FIG. 7 is a diagram for explaining the operation of the information processing apparatus in a second embodiment;

FIG. 8 is a diagram for explaining the operation of the information processing apparatus in a modification of the second embodiment; and

FIG. 9 is a diagram for explaining the operation of the information processing apparatus in a modification of the first embodiment.

### DESCRIPTION OF THE PREFERRED EMBODIMENTS

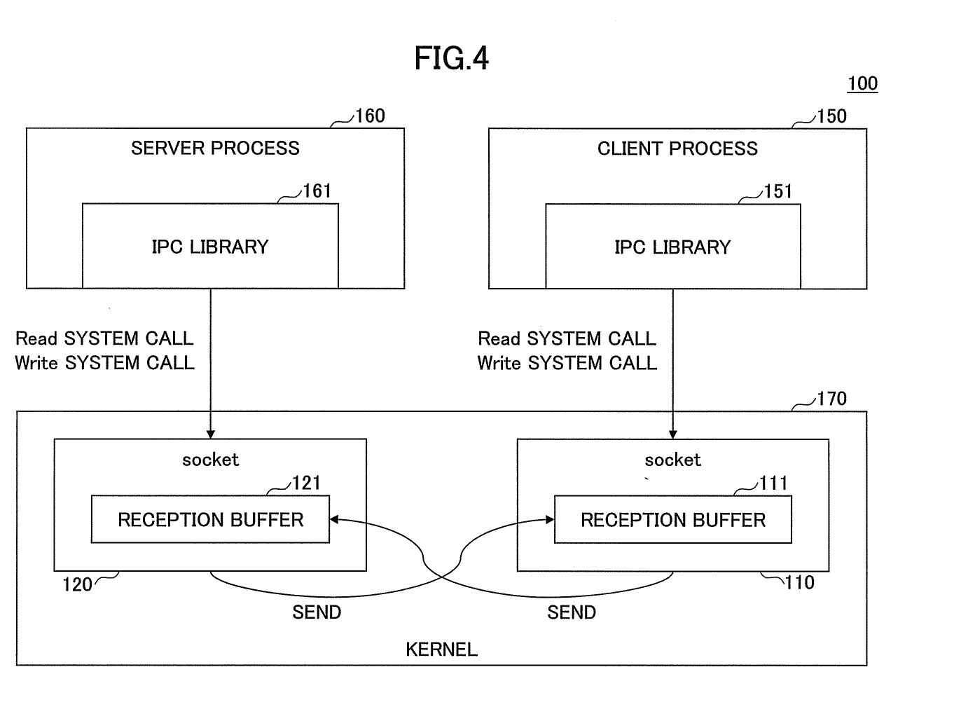

A description will be given of embodiments of an information processing apparatus, an information processing method and a computer-readable storage medium, by referring to FIG. 4 and the subsequent figures.

The computer-readable storage medium stores an information processing program which, when executed by a computer, causes the computer to perform a process comprising procedures of the information processing method described hereunder or, causes the computer to function as elements or units forming the information processing apparatus described hereunder. Of course, the computer-readable storage medium may be formed by any suitable recording media, including semiconductor memory devices and recording media such as magnetic, optical and magneto optical recording media.

FIG. 4 is a diagram illustrating software hierarchical layers of an information processing apparatus 100 in a first embodiment of the present invention.

The information processing apparatus 100 illustrated in FIG. 4 includes a client process 150, a server process 160, and a kernel 170. A memory corruption that occurs within a region of each of the client process 150, the server process 160, and the kernel 170 will not affect another region. For example, even if a memory corruption occurs within the server process 160, this memory corruption will not affect the client process 150 nor the kernel 170.

The client process 150 is provided with an IPC library 151, which is an aggregate of programs that execute processes related to the IPC. Similarly, the server process 160 is provided with an IPC library 161, which is an aggregate of programs that execute processes related to the IPC. The client process 150 makes Read and Write system calls with respect to the kernel 170 by utilizing functions of the IPC library 150. The server process 160 makes Read and Write system calls with respect to the kernel 170 by utilizing functions of the IPC library 161.

The kernel 170 is provided with sockets 110 and 120 respectively having reception buffers 111 and 121. The socket 110 sends message packets with respect to the reception buffer 121 within the socket 120, and the socket 120 sends message packets with respect to the reception buffer 111 within the socket 110.

### First Embodiment

A description will be given of a socket log acquisition within the Operating System (OS), that is, the kernel 170. In this embodiment, the log is acquired in a kernel space 140 within the OS. Various IPC implementation systems exist, but it is assumed for the sake of convenience that this embodiment uses a Berkeley Software Distribution (BSD) socket.

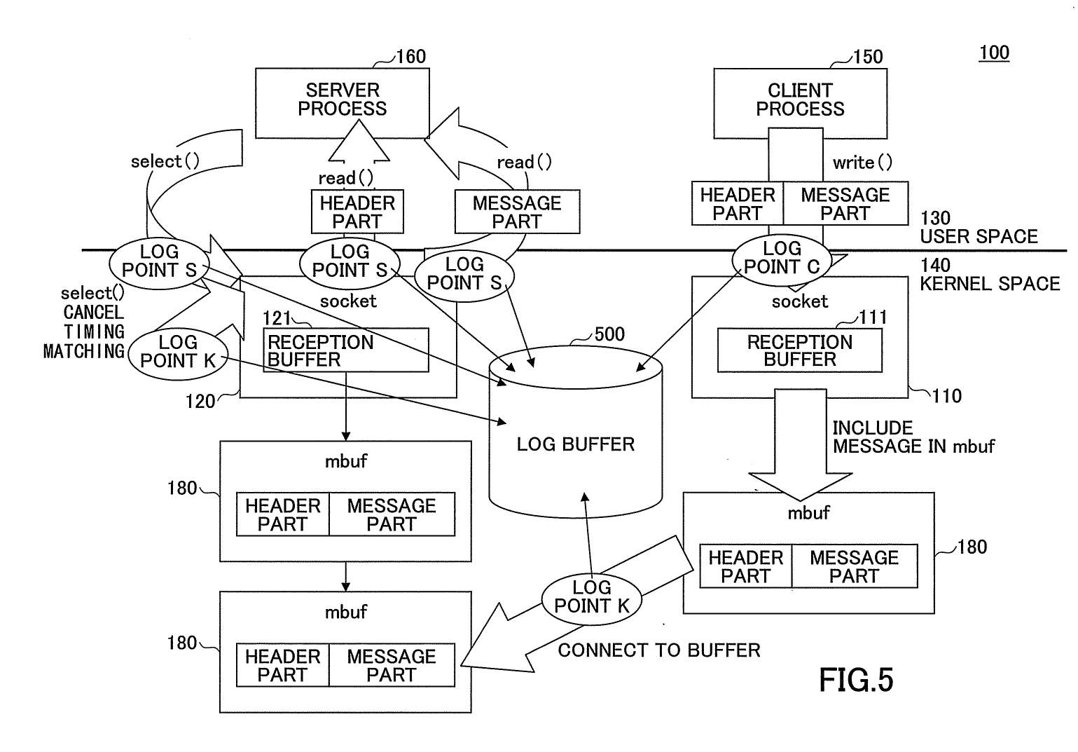

FIG. 5 is a diagram for explaining an operation of the information processing apparatus 100 in this embodiment. When the client process 150 sends a message to a server process 160, the client process 150 first prepares a message packet, as indicated by “write( )”. The message packet is not sent from the client process 150 within a user space 130 directly to the server process 160, but is first delivered to a reception buffer 111 of a socket 110 of an Operating System (OS) within the kernel space 140. The kernel includes the message packet by a mbuf buffer 180, as indicated by “include message by mbuf”.

As illustrated in FIG. 5, the log in the kernel space 140 is acquired at three (3) kinds of locations, namely, a log point C, a log point S, and a log point K, and recorded in a log buffer 500. Purposes of the log points C, S, and K are different, as described hereunder.

Log Point C:

The log point C is for acquiring the log for the purposes of confirming a client program operation. It is possible to confirm from the log acquired at the log point C that the client program has definitely sent a message. In addition, it is possible to confirm from the log acquired at the log point C that the message has intended contents.

Log Point S:

The log point S is for acquiring the log for the purposes of confirming a server program operation. It is possible to confirm from the log acquired at the log point S that the server program has definitely received a message. In addition, it is possible to confirm from the log acquired at the log point S that the message has intended contents.

Log Point K:

The log point K is for acquiring the log for the purposes of confirming a kernel operation. It is possible to confirm from the log acquired at the log point K that the kernel has definitely distributed a message. In addition, it is possible to confirm from the log acquired at the log point K that the server program has been made a scheduling target by the distribution of the message. It is known from experience that a problem often occurs in a process that is made the scheduling target, and thus, the log acquired at the log point K is effective for making the above confirmations.

Next, a description will be given of each of the log points C, S, and K illustrated in FIG. 5.

(1) Location where Packets are Sent from Client Process 150 to Client End Socket 110 within OS:

The log is acquired at an entrance of the packets being sent from the user space 130 to the kernel space 140, and the log is recorded. In a case where the size information in the header part of the packet is not equal to the overall size of the packet, there is a possibility that a memory corruption has occurred within the user space 130.

(2) Location where Connection is Made from Client End Socket 110 to Reception Buffer 121 of Server End Socket 120:

The sockets 110 and 120 are not limited to treating IPC packets. Hence, an inspection may be made to determine whether the packet has been delivered to the server end socket 120 on the side of the server process 160.

(3) Location where Timing Matching is Cancelled by Server Process 160 Upon Arrival of Packet to Buffer of Socket:

The server process 160 matches the arrival timings of the packets by the “select( )” system call, however, a trouble (or discrepancy or problem) is often found because of the compatibility of the “select( )” system call and a thread library. Hence, it is possible to analyze such a trouble by acquiring a log regarding whether the “select( )” system call has been cancelled by the packet link to the reception buffer 121.

(4) Location where Server Process 160 Reads Header of Packet from Socket 120:

The IPC library 161 of the server process 160 first reads the header part of the packet, and recognizes the size of the remainder (that is, the message part) of the packet.

(5) Location where Sever Process 160 Reads Remainder of Packet from Socket 120:

The server process 160 reads the remainder of the packet from the socket 120. The packet is actually sent from the client process 150 to the server process 160 by the above described procedures. If for some reason the size that is read is different from the size of the remainder of the packet arrived at the socket 120, an error end of the “read( )” occurs. When such an error end occurs, a memory corruption may have occurred.

By providing the log points C, S, and K described above, it becomes possible to debug the packet distribution state within the kernel space 140. In addition, it is possible to check whether the packet entering the kernel space 140 from the user space 130 has arrived with a correct (or normal) format, as described above under “(1) Location Where Packets Are Sent From Client Process 150 To Client End Socket 110 Within OS”, for example.

### Second Embodiment

A description will now be given of a second embodiment of the present invention, in which only IPC packets are log acquisition targets.

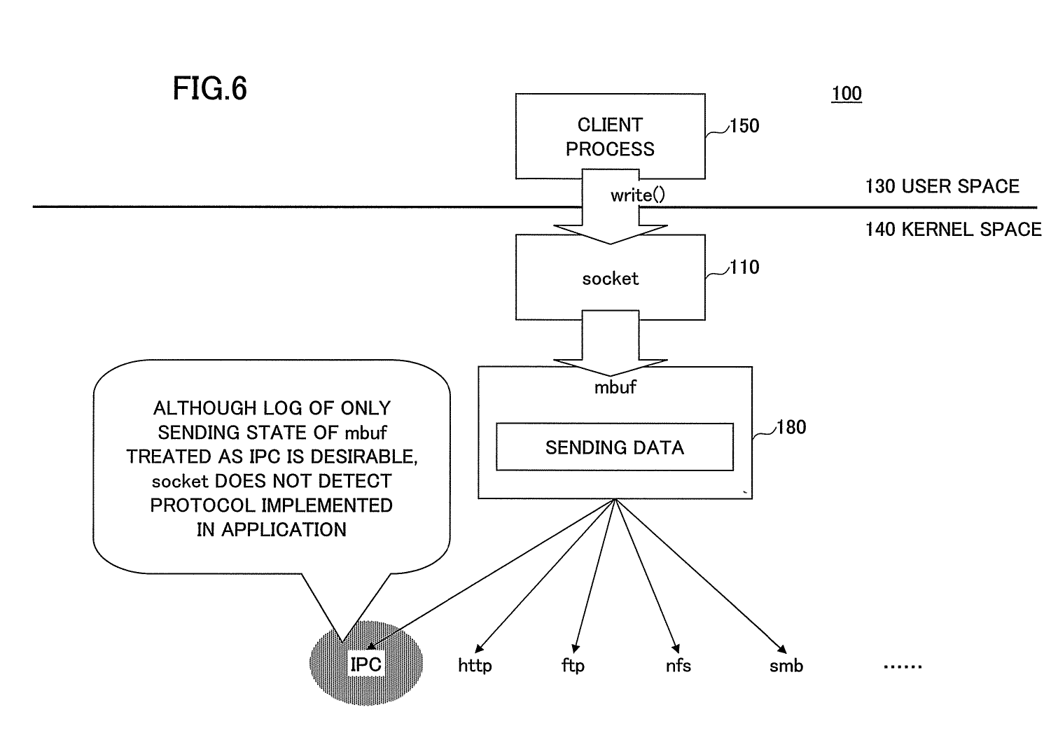

In the first embodiment described above, the log points are provided with respect to the packet distribution code via the socket 110. However, as illustrated in FIG. 6, the packets passing through the socket 110 are not limited to the IPC packets. FIG. 6 is a diagram for explaining an operation of a general socket, and the mbuf buffer 180 contains sending data. In FIG. 6, those parts that are the same as those corresponding parts in FIGS. 4 and 5 are designated by the same reference numerals, and a description thereof will be omitted.

The socket is a mechanism for treating the network as a general-purpose network, and the IPC is a communication technique that utilizes the socket. Naturally, when another socket treats a protocol, the packet may not have a header part with the IPC format.

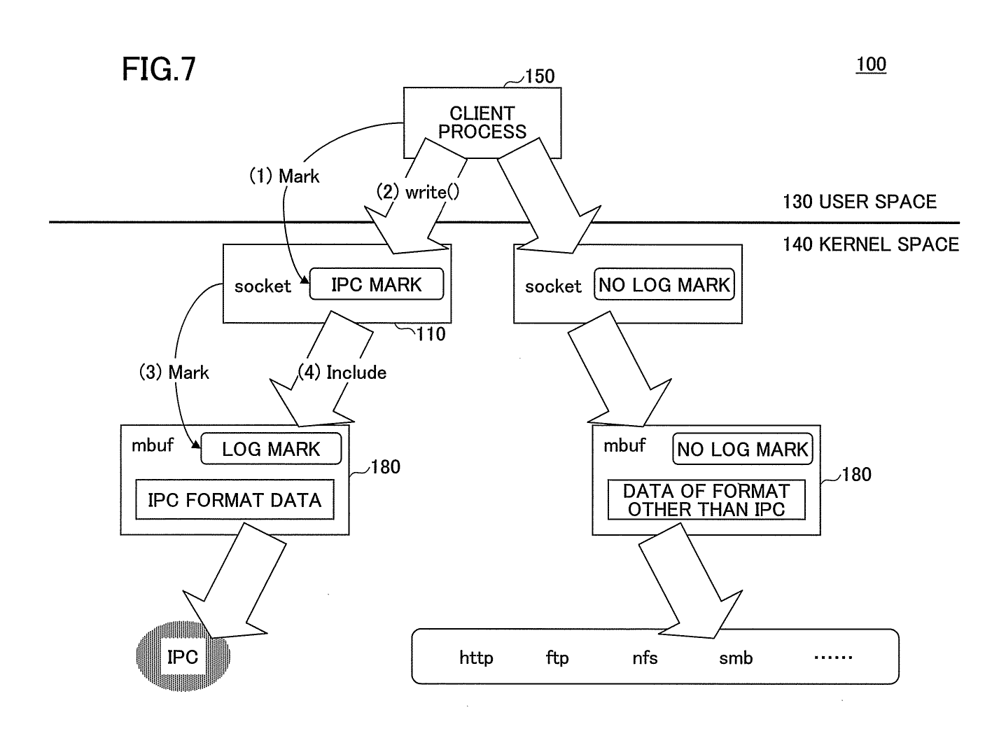

Hence, in the second embodiment, the client process 150, after connecting the server process 160 and the IPC socket 120, assigns an 120 mark in the socket 110, as illustrated by “(1) Mark” in FIG. 7, to indicate that the socket 110 is exclusively for the IPC. FIG. 7 is a diagram for explaining the operation of the information processing apparatus in the second embodiment. In FIG. 7, those parts that are the same as those corresponding parts in FIGS. 4 and 5 are designated by the same reference numerals, and a description thereof will be omitted. After assigning the IPC mark, the client process 150 performs a packet “write( )” with respect to the client end socket 110, as indicated by “(2) Write( )”. Responsive to this packet “write( )”, a socket management code of the kernel space 140 assigns a log mark to the packet received by the socket 110 that is assigned the IPC mark, as indicated by “(3) Mark”, when including this packet received by the socket 110 by the mbuf buffer 180 as indicated by “(4) Include”. Consequently, the log mark is always assigned to the mbuf buffer 180 of the IPC packet, that is, the packet related to the IPC.

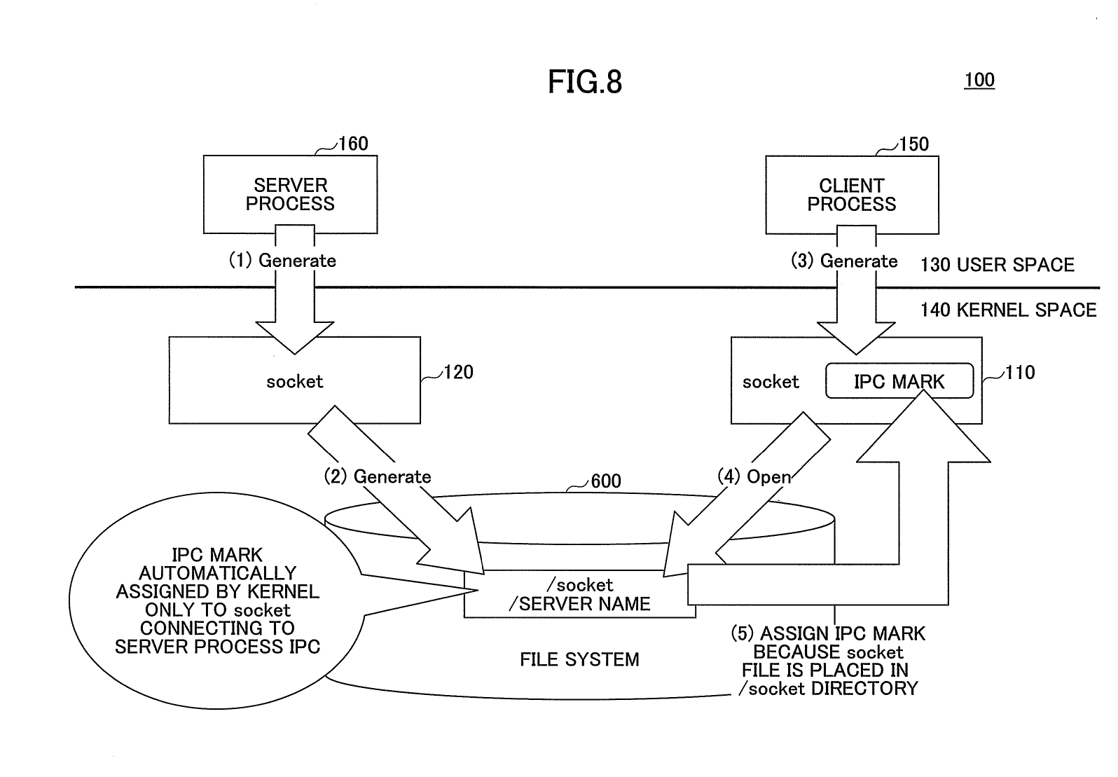

Instead of assigning the log mark to the mbuf buffer of the IPC packet as in this second embodiment, the IPC may generate a socket file in a file system 600 of a system (in the kernel space 140) when the server process 160 opens an IPC port, as in a modification illustrated in FIG. 8. FIG. 8 is a diagram for explaining the operation of the information processing apparatus in this modification of the second embodiment. In FIG. 8, those parts that are the same as those corresponding parts in FIGS. 4 and 5 are designated by the same reference numerals, and a description thereof will be omitted. If a rule is created in the IPC library in order to generate a socket file generating location in a predetermined directory such as “/socket”, as indicated by “(1) Generate” and “(2) Generate” in FIG. 8, the OS assigns an IPC mark to the socket 110 when the client process 150 attempts to open the socket 110 with respect to the socket file generated in the directory “/socket”, as indicated by “(3) Generate” and “(4) Open” in FIG. 8. The Kernel automatically assigns the IPC mark only to the socket 110 connecting to the IPC of the server process 160, as indicated by “(5) Assign IPC Mark Because Socket File Is Placed In/socket Directory” in FIG. 8. Thereafter, the log mark is assigned to the mbuf buffer passing the socket 110 having the IPC mark assigned thereto, in a manner similar to the second embodiment described above in conjunction with FIGS. 6 and 7.

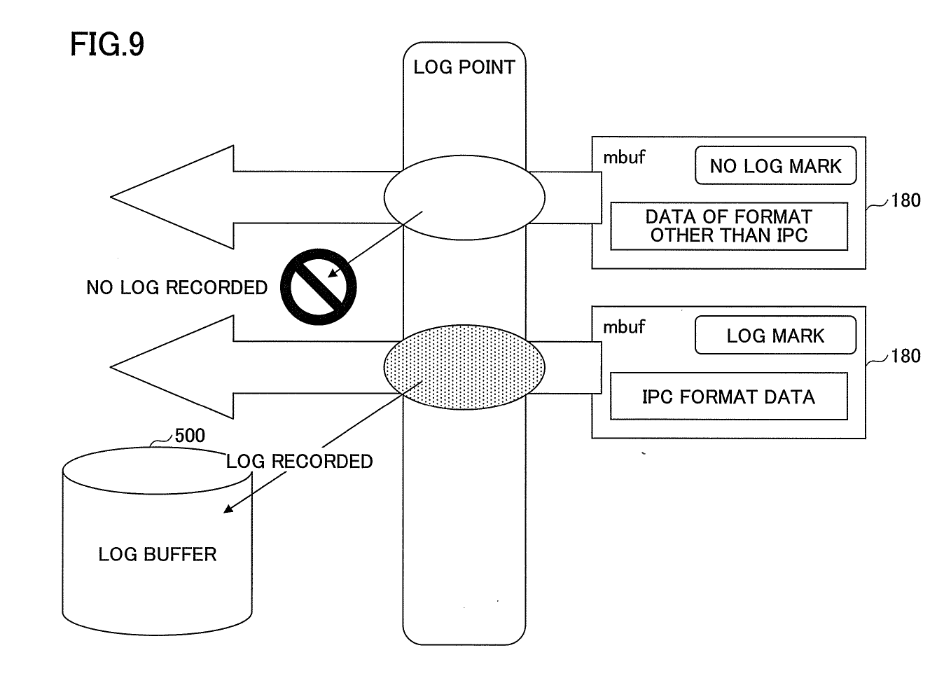

The log mark may be assigned to the mbuf buffer in the above described manner. Further, at a log point within the kernel space 140, such as that of the first embodiment described above, only the mbuf buffer having the log mark assigned thereto may be made the log acquisition target, as illustrated in FIG. 9. FIG. 9 is a diagram for explaining the operation of the information processing apparatus in a modification of the first embodiment. In FIG. 9, those parts that are the same as those corresponding parts in FIGS. 4 and 5 are designated by the same reference numerals, and a description thereof will be omitted. FIG. 9 illustrates an example where the upper mbuf buffer 180 includes no log mark and data of a format other than IPC, and the lower mbuf buffer 180 includes a log mark and IPC format data. No log is recorded at a log point for the upper mbuf buffer 180, while a log is recorded at the log point for the lower mbuf buffer 180 and recorded in the log buffer 500. By employing such a log acquisition and recording system, it is possible to make only the IPC packet related to the IPC the log acquisition target, among the packets passing the general socket system.

Therefore, according to one aspect of the disclosed information processing apparatus, a log of the behavior of the OS may be recorded, and the packet that arrives at the OS may be analyzed. For this reason, a trouble caused by a memory corruption within the user space may be detected.

According to one aspect of the disclosed information processing apparatus, the OS may recognize a socket secured for the IPC. Hence, the OS may judge the packet that is the log recording target.

According to one aspect of the disclosed information processing apparatus, the network distribution system of the OS may identify or discriminate the IPC packets and the packets other than the IPC packets. Thus, the OS may record a log by only focusing on the IPC packets. In addition, even if a trouble such as a distribution of a packet to a location completely unrelated to the IPC should occur, the trouble may be tracked by appropriately setting the log recording point.

According to one aspect of the disclosed information processing apparatus, because the log is recorded within the OS, a definite delivery of the packet to the OS may be detected. An error may be detected by inspecting the packet contents when the packet is delivered to the OS. Moreover, a trouble in the network distribution system within the OS may be analyzed from the log. Furthermore, an inspection may be made to determine whether the cause of the “select( )” function being cancelled was the arrival of the packet.

According to one aspect of the disclosed information processing apparatus, a log may record whether the “read( )” system call is delivered to the OS. Hence, when the “select( )” function is cancelled, an inspection may be made to determine whether an IPC thread of the server has normally resumed operation.

According to one aspect of the disclosed information processing apparatus, the OS may check whether the “read( )” system call is attempting to read a size identical to that of the IPC packet, and a check may be made to determine whether the information within the header part of the packet is equal to the overall size of the packet. As a result, a memory corruption within the OS or caused by a IPC sending source user program may be detected.

Further, the present invention is not limited to these embodiments, but various variations and modifications may be made without departing from the scope of the present invention.

What is claimed is:

1. An information processing apparatus comprising:
a communication unit configured to perform an inter-process communication via a kernel space among a plurality of processes existing in a user space; and
a log recording unit configured to record a log of the inter-process communication within the kernel space.

2. The information processing apparatus as claimed in claim 1, wherein the log recording unit comprises a plurality of kinds of locations including:
a first log point to acquire a log for purposes of confirming an operation of a client program;
a second log point to acquire a log for purposes of confirming an operation of a server program; and
a third log point to acquire a log for purposes of confirming an operation of a kernel.

3. The information processing apparatus as claimed in claim 2, wherein the recording unit records a log at one or a plurality of locations selected from a group consisting of:
a location to write a packet sent from a sending end process to a sending end socket buffer;
a location to connect the packet to a receiving end socket buffer;
a location to cancel matching of arrival timings of packets of a predetermined function called by a receiving end process;
a location to read a header part of the packet by the receiving end process; and
a location to read a message part of the packet by the receiving end process.

4. The information processing apparatus as claimed in claim 3, wherein:
the sending end socket is exclusively for the inter-process communication and assigns, with respect to a packet sent from the sending end process, a mark indicating that the packet is related to the inter-process communication; and
the log recording unit records a log related to the packet having the identification information assigned thereto.

5. An information processing method, comprising:
performing, by a computer, an inter-process communication via a kernel space among a plurality of processes existing in a user space; and
recording, by the computer, a log of the inter-process communication within the kernel space.

6. The information processing method as claimed in claim 5, wherein said recording uses a plurality of kinds of locations including:
a first log point to acquire a log for purposes of confirming an operation of a client program;
a second log point to acquire a log for purposes of confirming an operation of a server program; and
a third log point to acquire a log for purposes of confirming an operation of a kernel.

7. The information processing method as claimed in claim 6, wherein said recording records a log at one or a plurality of locations selected from a group consisting of:
a location to write a packet sent from a sending end process to a sending end socket buffer;
a location to connect the packet to a receiving end socket buffer;
a location to cancel matching of arrival timings of packets of a predetermined function called by a receiving end process;
a location to read a header part of the packet by the receiving end process; and
a location to read a message part of the packet by the receiving end process.

8. The information processing method as claimed in claim 7, wherein:
the sending end socket is exclusively for the inter-process communication and assigns, with respect to a packet sent from the sending end process, a mark indicating that the packet is related to the inter-process communication; and
said recording records a log related to the packet having the identification information assigned thereto.

9. A computer-readable storage medium that stores a program which, when executed in a computer, causes the computer to perform a process comprising:
a communication procedure causing the computer to perform an inter-process communication via a kernel space among a plurality of processes existing in a user space; and
a log recording procedure causing the computer to record a log of the inter-process communication within the kernel space.

10. The computer-readable storage medium as claimed in claim 9, wherein the log recording procedure causes the computer to use a plurality of kinds of locations including:
a first log point to acquire a log for purposes of confirming an operation of a client program;
a second log point to acquire a log for purposes of confirming an operation of a server program; and
a third log point to acquire a log for purposes of confirming an operation of a kernel.

11. The computer-readable storage medium as claimed in claim 10, wherein the recording procedure causes the computer to record a log at one or a plurality of locations selected from a group consisting of:
a location to write a packet sent from a sending end process to a sending end socket buffer;
a location to connect the packet to a receiving end socket buffer;
a location to cancel matching of arrival timings of packets of a predetermined function called by a receiving end process;
a location to read a header part of the packet by the receiving end process; and
a location to read a message part of the packet by the receiving end process.

12. The computer-readable storage medium as claimed in claim 11, wherein:
the sending end socket is exclusively for the inter-process communication and assigns, with respect to a packet sent from the sending end process, a mark indicating that the packet is related to the inter-process communication; and
the log recording procedure causes the computer to record a log related to the packet having the identification information assigned thereto.
